(19) United States
(12) Patent Application Publication
(10) Pub. No.: US 2016/0324078 A1
(43) Pub. Date: Nov. 10, 2016

(54) WASTE ENERGY RECYCLING SYSTEM

(71) Applicant: Houweling Nurseries Oxnard, Inc., Camarillo, CA (US)

(72) Inventors: Casey Houweling, Delta (CA); Geurt Reinders, Almelo (NL)

(21) Appl. No.: 15/148,914

(22) Filed: May 6, 2016

Related U.S. Application Data
(60) Provisional application No. 62/158,806, filed on May 8, 2015.

(51) Int. Cl. A01G 9/24; F23J 15/02

(52) U.S. Cl. CPC A01G 9/24; F23J 15/022; F23J 2219/70

(57) ABSTRACT

Disclosed herein are methods, systems and devices providing efficient power plant waste energy and waste product recycling for use in other building structures, such as greenhouses. In some embodiments, heat from exhaust gas from a power plant is transferred to a liquid in a condenser, which can also remove impurities and contaminates from the exhaust gas and can increase the carbon dioxide concentration of the exhaust gas. The heated liquid is then used to provide heat to the greenhouse, while the exhaust gas is used to provide carbon dioxide to the greenhouse. In some embodiments, the condenser utilizing “return liquid” from the greenhouse. In some embodiments, the waste heat and waste products can be stored for later use.

### CROSS REFERENCE TO RELATED APPLICATIONS

This application claims the benefit of U.S. Provisional Application Ser. No. 62/158,806 to Casey Houweling, et al., entitled WASTE ENERGY RECYCLING SYSTEM, filed on May 8, 2015, which is hereby incorporated herein in its entirety by reference.

### BACKGROUND

1. Field of the Invention

Described herein are devices, systems and methods relating generally to the recycling of waste energy and products, such as waste heat and carbon dioxide produced by one structure, such as a power plant, and specifically to the use of the waste energy and products for use in providing heat and/or gas to another structure, for example, providing heat and carbon dioxide to a greenhouse.

2. Description of the Related Art

Power plants and other large energy-using building structures, such as various processing and treatment plants, are a ubiquitous sight in modern society. Power plants, for example, provide energy for use by cities and allow for continuous and regular energy utilization. One unfortunate side effect of the ordinary operation of power plants is the production of waste energy, typically in the form of heat, and other waste products, such as carbon dioxide. Absent any other structures or innovations, the waste produced by power plants is simply lost and serves no greater purpose. Furthermore, as society becomes more environmentally conscience, there is increasing demand and motivation to make use of this waste.

One use for power plant waste that is especially relevant is utilization of the power plant waste by a nearby greenhouse. Greenhouses, which grow various plant-based crops can make ready use of the natural by-products of most power plants, namely heat and carbon dioxide. To this end, various systems were developed in an attempt to maximize the efficiency of utilizing waste from a power plant to provide energy to a greenhouse. On example of such a system is set forth in US Patent Pre-Grant Publication No. 2014/0026473 to Chen, et al., entitled METHOD AND DEVICE FOR SUPPLYING HEAT ENERGY AND CARBON DIOXIDE FROM EXHAUST GAS FOR VEGETABLE AND/OR ALGAE PRODUCTION.

Some disadvantages of many conventional power plant waste-recycling systems include that they cannot store waste energy for later use and that they are only effective in efficiently extracting a significant amount of heat if they are utilized in conjunction with older, inefficient power plant designs. For example, as in the case of the systems disclosed in US Patent Pre-Grant Publication No. 2014/0026473, some systems utilize only air-to-air heat exchangers, wherein the energy is not stored for later use. Furthermore, these systems require many multiple stages and are thus inefficient.

Still other disadvantages of conventional power plant waste recycling systems include systems utilizing extraction of heat from coolant water that is utilized to cool steam produced by the power plants. In these systems, power plant steam utilized in the production of electricity (for example, in the turning of turbines) is condensed so that the steam can be transported across the system utilizing pumps. In such systems, the waste heat obtained from the power plant for use in another structure (such as a greenhouse) depends on the existence of a significant heat differential between the produced steam and the coolant water. However, in newer, more efficient power plant designs, a vacuum is utilized, causing excess generated steam to be created at relatively low temperatures (typically around 40 degrees Celsius). After the generation of steam in these more efficient power plants, the pressure of the steam is increased, causing the gas-to-liquid transition temperature to rise, causing the required condensation and limiting the amount of heat that can be extracted by such a conventional system.

### SUMMARY

Disclosed herein are methods, devices and systems providing for efficient waste energy and/or waste product recycling from power plants, that allow for use of the waste energy and products in another building structure, for example, a greenhouse. In some embodiments, carbon dioxide gas and waste heat can be transferred from exhaust gas produced by the power plant to a greenhouse for use in crop production. In some embodiments, exhaust gas from the power plant is condensed, such that it transfers its heat to a liquid for use in heating the greenhouse, which increases the carbon dioxide level of the exhaust gas, and removes contaminates from the exhaust gas, such that the gas can also be effectively utilized in the greenhouse.

Methods, systems and devices incorporating features of the present invention can comprise various other additional features, such as storage features for storing waste energy and waste products, such as storing heat in the form of heated liquid in a water storage tank. In some embodiments, systems can be automated and can comprise sensors for monitoring variables, such as carbon dioxide level and temperature. A computer can receive signals from these sensors and can adjust the levels of heat and carbon dioxide transferred to the greenhouse accordingly.

In one embodiment incorporating features of the present invention, a waste energy recycling system comprises a power plant, one or more condensers configured to receive and condense exhaust gas from the power plant, thus removing vapor and contaminants from the exhaust gas, and a greenhouse configured to receive the condensed exhaust gas.

In another embodiment, a waste energy recycling system for use with a greenhouse comprises a power plant, one or more condensers configured to receive exhaust gas from the power plant and transfer heat from the exhaust gas to liquid within the condensers, and one or more liquid-to-air heat exchangers configured to receive the heated liquid from the condensers and transfer heat from the heated liquid to air within the greenhouse.

In yet another embodiment, a waste energy recycling system for use with a greenhouse comprises a power plant which produces exhaust gas comprising carbon dioxide, one or more condensers configured to receive the exhaust gas from the power plant and transfer heat from the exhaust gas to liquid within the condensers, therefore removing at least some vapor and contaminants from the exhaust gas and producing treated exhaust gas with a higher concentration of carbon dioxide, one or more conduits configured to transport the treated exhaust gas to the greenhouse, and one or more liquid-to-air heat exchangers in the greenhouse, and one or more liquid-to-air heat exchangers configured to receive the heated liquid from the condensers and transfer heat from the heated liquid to air within the greenhouse.

These and other further features and advantages of the invention would be apparent to those skilled in the art from the following detailed description, taken together with the accompanying drawings, wherein like numerals designate corresponding parts in the figures, in which:

### BRIEF DESCRIPTION OF THE DRAWINGS

FIG. 1 is a schematic representation of a waste energy recycling system incorporating features of the present invention;

FIG. 2 is a front plan view of an embodiment of an implementation of a waste energy recycling system incorporating features of the present invention; and

FIG. 3 is a top plan view of the waste energy recycling system of FIG. 2.

### DETAILED DESCRIPTION

The present disclosure will now set forth detailed descriptions of various embodiments. These embodiments set forth methods, devices and systems providing for efficient waste energy and/or waste product recycling from power plants. In some embodiments, waste energy can be stored for later use, for example, storing heat in the form of heated water and/or storing carbon dioxide.

Methods, systems and devices incorporating features of the present invention can include one or more condensers that can accept exhaust gas from the power plant and can condense the gas into a liquid condensate by transferring heat from the gas to a liquid, such as water. The condensate can be flushed from the system and can remove impurities and other contaminants from the exhaust gas. The liquid in the condenser to which the heat was transferred can then be stored for later use and/or immediately utilized to transfer heat to the greenhouse. The treated exhaust gas, which now comprises a higher concentration of carbon dioxide and a lower concentration of contaminants and impurities, can also then be provided to the greenhouse.

In some embodiments, the liquid utilized by the condenser can comprise “return liquid” or “return water,” which is water or another liquid that has been previously stored and/or utilized by the greenhouse. This allows the liquid to be recycled and to keep the differential in temperature high, as the temperature of liquid that has transferred heat to the greenhouse will be relatively low in comparison with the exhaust gas heat. This is particularly effective when utilized with efficient greenhouse designs that can capitalize off the heat transfer and thus keep the temperature of the return water low.

Throughout this description, the preferred embodiment and examples illustrated should be considered as exemplars, rather than as limitations on the present invention. As used herein, the term “invention,” “device,” “system,” “method,” “present invention,” “present device,” “present system” or “present method” refers to any one of the embodiments of the invention described herein, and any equivalents. Furthermore, reference to various feature(s) of the “invention,” “device,” “system,” “method,” “present invention,” “present device,” “present system” or “present method” throughout this document does not mean that all claimed embodiments or methods must include the referenced feature(s).

It is also understood that when an element or feature is referred to as being “on” or “adjacent” to another element or feature, it can be directly on or adjacent the other element or feature or intervening elements or features may also be present. It is also understood that when an element is referred to as being “attached,” “connected” or “coupled” to another element, it can be directly attached, connected or coupled to the other element or intervening elements may be present. In contrast, when an element is referred to as being “directly attached,” “directly connected” or “directly coupled” to another element, there are no intervening elements present.

Relative terms, such as “outer,” “above,” “lower,” “below,” “horizontal,” “vertical” and similar terms, may be used herein to describe a relationship of one feature to another. It is understood that these terms are intended to encompass different orientations in addition to the orientation depicted in the figures.

Although the terms first, second, etc. may be used herein to describe various elements or components, these elements or components should not be limited by these terms. These terms are only used to distinguish one element or component from another element or component. Thus, a first element or component discussed below could be termed a second element or component without departing from the teachings of the present invention. As used herein, the term “and/or” includes any and all combinations of one or more of the associated list items.

The terminology used herein is for describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” when used herein, specify the presence of stated features, integers, steps, operations, elements, and/or components, but do not preclude the presence or addition of one or more other features, integers, steps, operations, elements, components, and/or groups thereof.

Embodiments of the invention are described herein with reference to different views and illustrations that are schematic illustrations of idealized embodiments of the invention. As such, variations from the shapes of the illustrations as a result, for example, of manufacturing techniques and/or tolerances are expected. Embodiments of the invention should not be construed as limited to the particular shapes of the regions illustrated herein, but are to include deviations in shapes that result, for example, from manufacturing.

It is understood that when a first element is referred to as being “between,” “sandwiched,” or “sandwiched between,” two or more other elements, the first element can be directly between the two or more other elements or intervening elements may also be present between the two or more other elements. For example, if a first element is “between” or “sandwiched between” a second and third element, the first element can be directly between the second and third elements with no intervening elements or the first element can be adjacent to one or more additional elements with the first element and these additional elements all between the second and third elements.

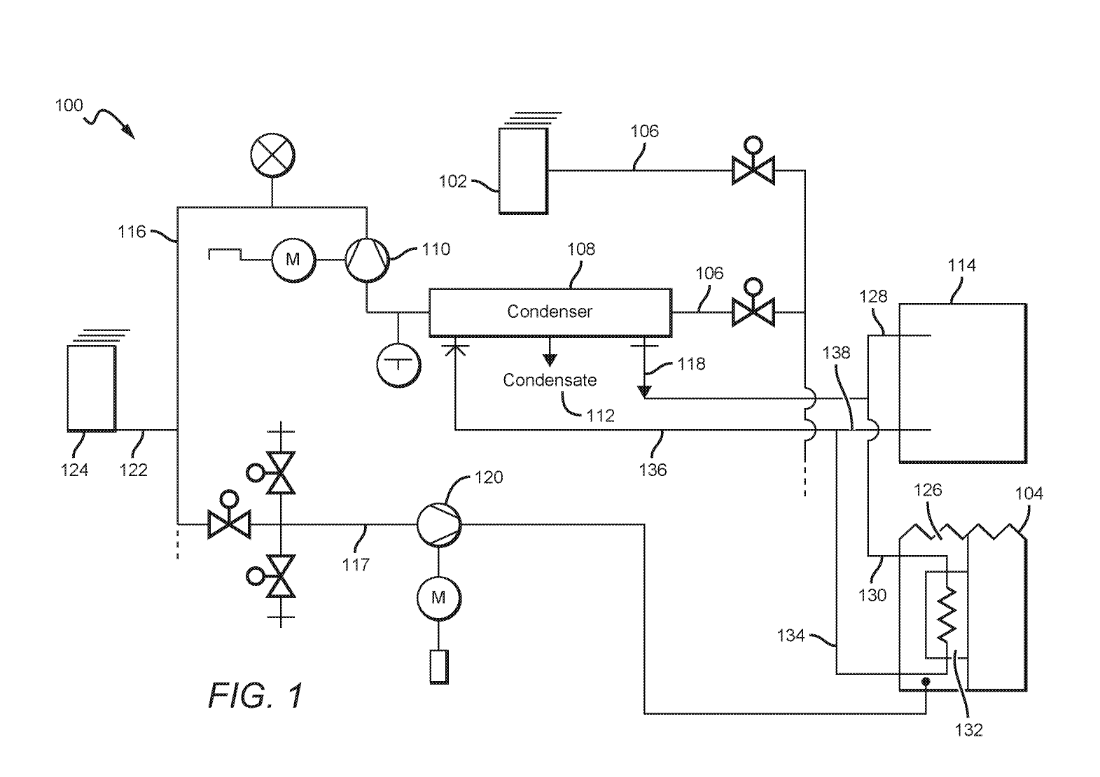

An example embodiment of a waste energy recycling system 100 is shown in FIG. 1, which shows a power plant 102 and a greenhouse 104, along with various other features according to the present disclosure, which will be discussed further herein. The power plant 102 can be any gas and/or heat producing building structure, for example, a power plant that produces waste exhaust in the form of carbon dioxide. While the greenhouse 104 is referred to herein as a greenhouse, it is understood that any building structure or area that can benefit from embodiments incorporating features of the present invention can utilize the systems, devices and methods herein and that such uses are within the scope of the present disclosure.

In embodiments utilizing a greenhouse 104, any greenhouse known in the art can be utilized, however, the systems work best when utilized with highly efficient greenhouses, such as semi-closed greenhouses. An example of a particularly efficient greenhouse can be found in U.S. Pat. No. 8,707,617, to Houweling, filed on Jun. 28, 2007, entitled GREENHOUSE AND FORCED GREENHOUSE CLIMATE CONTROL SYSTEM AND METHOD, which is hereby incorporated herein in its entirety by reference.

In the absence of a waste energy recycling system, heat and exhaust gas, such as carbon dioxide, are exhausted from the power plant 102, for example, from a chimney structure. In some embodiments, in which the power plant 102 comprises a heat recovery steam generator (HRSG), the “exhaust gas” for the waste energy recycling system can be provided in the form of steam and/or other emissions from the HRSG. In utilizing the waste energy recycling system 100 of FIG. 1, the heat and exhaust gas are instead routed through one or more conduits (such as a first conduit 106) to one or more condensers 108 (one shown) by one or more transportation mechanisms (such as a first transport mechanism 110).

The first conduit 106, as well as any other conduits disclosed herein, can comprise any material and configuration suitable for the distribution of fluids, such as liquids and gasses, including any distribution conduit materials and configurations that are known in the art. In some embodiments, the conduits are configured to transport high temperature heated liquid or gas. The first transportation mechanism 110 can be any mechanism capable of transporting the exhaust gas through the first conduit 106, including a mechanism that creates a negative pressure that can control the gas flow or any gas transport mechanism known in the art. In some embodiments, the one or more transport mechanisms 110 can comprise one or more fans configured to create a negative air pressure downstream of where the exhaust gas is intended to travel. In some embodiments, the first conduit 106, which is configured to transport exhaust from the power plant 102 to the greenhouse 104, comprises glass-fiber reinforced plastic (GRP) and/or a vinyl ester compound.

The one or more condensers 108 can comprise any condenser mechanism capable of condensing the exhaust gases, including any condenser known in the art. In many modern efficient conventional power plants, the temperature of the exhaust gas is approximately 100 degrees Celsius. This would make the vapor content of the exhaust gas of such conventional power plants typically around 10% and the carbon dioxide level of the exhaust gas is around 5%, which is not a particularly significant level of carbon dioxide for transporting to a greenhouse for crop-growing purposes if utilized directly. Furthermore, prior to reaching the condenser 108 there are often other contaminants in the exhaust gases resulting from the combustion processes in the power plant that can potentially have a negative effect on greenhouse crop production if introduced directly into the greenhouse.

When the exhaust gases have been transported through first conduit 106 by transport mechanism 110, and have reached the condenser 108, a portion of the heat from the exhaust gases is transferred to water or coolant within the condenser. In some embodiments, the condenser utilizes “return liquid” that has been utilized by the greenhouse 104 or has been stored in a liquid storage tank 114, this return liquid is discussed in more detail further below. Typically water is the liquid utilized. Through normal operation of the condenser 108, the water is heated to around 45 degrees Celsius. The decrease in temperature of the exhaust gas caused by the heat transfer causes the vapor within the exhaust gas to condense, producing a condensate 112. The condensate 112 can be removed from the system and thus helps to flush out at least some of the contaminants within the exhaust gas, for example, chemical by-products or pollutants, mitigating their effect upon subsequent introduction into the greenhouse 104. In some embodiments, return liquid can be utilized by the condenser separately from the initial liquid the exhaust gas transfers heat to, for example, having a separate condenser for return liquid and initial liquid or can be configured to freely mix the initial liquid and return liquid.

After condensation of the exhaust gas has occurred, the resulting products, which include a treated gas (the exhaust gas from which at least some vapor and contaminants have been removed) and heated water. These two products of the condensation process are further utilized and transported across the waste energy recycling system 100. The treated gas can be transported through one or more conduits (such as a second conduit) 116 and the heated water is transported through one or more other conduits (such as a third conduit 118).

Focusing now on the treated gas, the treated gas resulting from the condensation process at the condenser 108 comprises a higher concentration of carbon dioxide, due to vapor being removed, and less contaminants than the originally produced exhaust gas from the power plant 102, making the treated gas more useful for introduction into the greenhouse to provide carbon dioxide to the crops within. The treated gas can be further separated, such that gas containing carbon dioxide is transported from the second conduit 116 through one or more additional conduits (such as a fourth conduit 117) by one or more transportation mechanisms (such as a second transportation mechanism 120 set forth herein). Gas leaving the condenser 108 that does not contain sufficient amounts of carbon dioxide or gas that is not immediately needed for the greenhouse 104, can be transported from condenser 108 through the second conduit 116 through one or more additional conduits (such as a fifth conduit 122) to an exhaust mechanism 124, where it is exhausted from the system.

The second transportation mechanism 120 can comprise the same materials and configurations as the first transportation mechanism 110, including a fan configured to generate negative pressure to transport the treated carbon dioxide gas to the greenhouse 104. The exhaust mechanism 124 can be any exhaust mechanism capable of exhausting unwanted gas from the system 100, including any exhaust mechanism known in the art. In some embodiments, the exhaust mechanism 124 comprises an exhaust chimney. In some embodiments, the exhaust mechanism 124 is a pre-existing exhaust mechanism utilized by the power plant 102.

In some embodiments, such as embodiments utilizing the greenhouses set forth in U.S. Pat. No. 8,707,617 mentioned above, the greenhouse 104 comprises a separate climate control system 126 configured to utilize ambient air, recirculated air from the growing section or a combination of both, and the treated gas can be introduced directly into the climate control system. These greenhouses are particularly efficient as the internal temperature can be controlled by adjusting the amount of ambient and recirculated air being utilized without the extensive use of heavy power-using cooling and heating devices.

Focusing now on the heated water from the condensation process, as previously mentioned, the heated water typically comprises a temperature of around 45 degrees Celsius. The heated water is transported from the condenser 108 through the third conduit 118 where it can be transported by one or more conduits (such as a sixth conduit 128) to the liquid storage tank 114 when the heated water is not needed for heating the greenhouse. The liquid storage tank 114 can include any liquid storage structure that is capable of securely storing liquid and which preferably can preserve the temperature of the liquid or at least mitigate transfer of temperature between the liquid and the storage tank or surrounding ambient air or ground when underground. Alternatively or in addition, the heated water can be transported through the third conduit 118 through one or more conduits (such as a seventh conduit 130) to one or more liquid-to-air heat exchangers 132 located inside or adjacent to the greenhouse 104.

It is understood that some embodiments of waste energy recycling systems incorporating features of the present invention can be configured to utilizing only one of the resulting products above, for example, only utilizing a condenser to heat liquid or only to produce treated exhaust gas. At least one advantage of utilizing a condenser to produce both treated exhaust gas and heated liquid is that heat and carbon dioxide can be utilized independently of one another. For example, a user would not need to rely on the temperature of the gas to transfer heat as heat transfer can be controlled through use of the heated liquid. Also, temperature via the heated liquid and carbon dioxide via the treated exhaust gas can be independently introduced to the greenhouse based upon the current needs of the greenhouse.

The liquid-to-air heat exchanger 132 can be configured to warm the air inside the greenhouse, for example, by transferring heat from the heated water to ambient and/or recirculated air in a greenhouse climate control system 126. After the heated water has been utilized to heat the greenhouse air, the water, now referred to as “return water” after it has undergone a heat exchange process at the liquid-to-air heat exchanger 132, can be transported through one or more conduits (such as an eighth conduit 134) from the liquid-to-air heat exchanger 132 to the condenser 108 and/or to one or more other conduits (such as a ninth conduit 136) to be once again utilized by the condenser to transfer exhaust heat produced from the power plant to the return water. In efficient greenhouses, the heat transfer between the heated water and the greenhouse air is optimized, for example, by transferring heat from the heated water to cooler ambient air in a separate climate control system before introducing it into a growing section, and thus much of the heat from the heated water is lost to the greenhouse air.

Alternatively or in addition to being reintroduced and utilized by the condenser 108, the return water, if by chance it still comprises a sufficiently warm temperature or if the temperature of stored heated water is to be reduced, can be transported from the eighth conduit 134 to one or more conduits (such as a tenth conduit 138) back to the liquid storage tank 114. In some embodiments, instead of the tenth conduit 138 being utilized for return water from the greenhouse 104 to be transported to the liquid storage tank 114, the tenth conduit 138 is configured to transport return water from the liquid storage tank 114 to the condenser 108. In some embodiments, there are conduits configured to transport water from the liquid storage tank to the condenser 108 and conduits configured to transport return water from the greenhouse 104 to the liquid storage tank.

By utilizing the return water from an efficiently designed greenhouse in the condenser 108, particularly efficient heat transfer from the exhaust gas to the return water is possible. In these embodiments, return water is only around a few degrees Celsius higher than the air temperature in the greenhouse. In some embodiments, the return water is only approximately one degree higher than the air temperature of the greenhouse. For illustrative example, if the greenhouse is heated to eighteen degrees Celsius, the return water from the heating system coming from the greenhouse into the energy building will be around nineteen degrees Celsius. This is due to the efficient greenhouse climate control features of greenhouses such as those set forth in U.S. Pat. No. 8,707,617. The low temperature of the return water, combined with the high temperature of the exhaust gases (as previous mentioned around 100 degrees Celsius) means there is a high temperature differential between the exhaust gases and the water, which causes the heat from the exhaust gases to be transferred to the return water efficiently.

In different embodiments incorporating features of the present invention, various control mechanisms can be utilized. These control mechanisms can comprise valves, dampers and other structures known in the art of fluid mechanics configured to control the flow of liquid or gas and/or divert it into various conduits. For example, in some embodiments, a control mechanism can be configured to control flow from the power plant 102 through first conduit 106 such that the exhaust gas from the power plant 106 can enter the condenser and/or be exhausted as waste. In some embodiments a control mechanism can be configured such that treated gas from the condenser 108 can travel through the fifth conduit 122 to be exhausted from the exhaust mechanism 124 and/or continue through the fourth conduit 117 be provided to the greenhouse 104. In some embodiments, a control mechanism can be configured such that heated water from the condenser 108 can travel through the third conduit 118 toward the sixth conduit 128 to the liquid storage tank 114 and/or through the seventh conduit 130 to the liquid-to-air heat exchanger 132. In some embodiments, a control mechanism can be configured such that return water from the greenhouse traveling through the eighth conduit 134 can travel through the ninth conduit 136 back to the condenser 108 and/or can travel through the tenth conduit 138 to the water storage tank 114.

It is understood that while various single conduits branching into multiple conduits are disclosed herein, for example, the third conduit 118 branching off into a sixth conduit 128 leading toward a liquid storage tank 114 and a seventh conduit 130 leading toward a liquid-to-air heat exchanger 132, that these conduits are shown in FIG. 1 schematically and that conduits branching into various other conduits can include literal conduits branching into other conduits and/or conduits configured to distribute fluid to and from multiple possible locations utilizing any known transport structures.

Various other conduit configurations can also be utilized according to the present disclosure. For example, instead of the branching arrangement, two separate conduits can be utilized to perform a similar function and lead from one structure to another. For example, one or more conduits can be configured to transport heated water from the condenser 108 to the water tank 114, while one or more other separate non-connected conduits can be configured to transport heated water from the condenser 108 to the liquid-to-air heat exchanger 132.

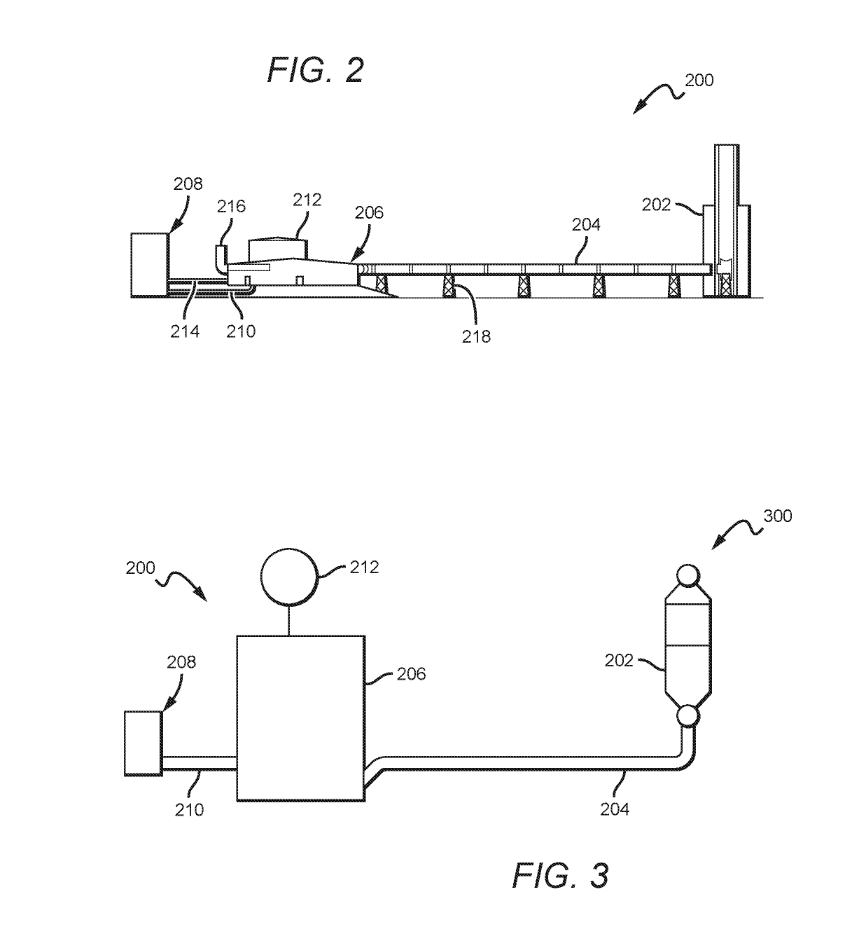

Some example implementations of systems incorporating features of the present invention are shown in FIGS. 2-3. FIG. 2 shows a waste energy recycling system 200 comprising a power plant HRSG 202, a power plant exhaust conduit 204, which is configured to transport exhaust from the power plant HRSG to a power building structure 206, which can house various condensers and other elements, such as those described above, although in other embodiments, the condensers and other elements can be housed directly in the power plant or greenhouse itself rather than a separate building structure. The condensers in the power building structure 206 can provide the heated water as described above and can transport the heated water to a greenhouse 208, for example, through heated water conduit 210, and/or can transport water to a liquid storage tank 212.

The power building structure 206 can also be configured to transport treated carbon dioxide containing air from the condensers to the greenhouse, for example, through treated air conduit 214, and/or exhaust the treated air from the system through exhaust mechanism 216. One or more of the conduits can also be supported by support structures 218, which can comprise any support structures known in the art to provide structural support to distribution conduits. FIG. 3 shows a top plan view 300 of the waste energy recycling system 200 in FIG. 2 above. FIG. 3 shows the power plant HRSG 202, the power plant exhaust conduit 204, the power building structure 206, the greenhouse 208, the heated water conduit 210 and the liquid storage tank 212.

It is understood that systems, devices and methods incorporating features of the present invention can be automated or manually controlled. In some embodiments, the system is controlled by one or more computers or other digital interfaces. In some embodiments, variable qualities can be monitored, measured and can be determined and/or reported to a user and can be utilized to determine operation of the system. Some examples of these variable qualities include, but are not limited to: air pressure throughout various points in the system, temperature of the greenhouse, temperature of the exhaust gas, temperature of the treated gas, temperature of the heated water, temperature of the return water, carbon dioxide levels in the greenhouse, carbon dioxide levels in the exhaust gas and carbon dioxide levels in the treated gas.

These variables can be detected with sensors, such as temperature, pressure and chemical sensors and the variables can be utilized by a user to make decisions as to how to manually operate the system and/or can be utilized by a computer to allow for automated control of the system. For example, a chemical sensor might detect a drop in carbon dioxide concentration in the greenhouse and can inform a user who could adjust the amount of treated gas being exhausted instead of being routed to the greenhouse or a computer can automatically adjust this after receiving a signal from the chemical sensor.

Systems, methods and devices incorporating features of the present invention can comprise additional “backup” features that can be utilized to provide heat and/or carbon dioxide to the greenhouse in the rare occurrences of a complete power plant shutdown. For example, reserve heating mechanisms, such as boilers can produce the steam for the system in absence of the power plant exhaust.

While a water/liquid storage tank has been described herein, the carbon dioxide containing gas can also be stored for later use, for example in a gas storage unit. The gas storage unit can be equipped with various safety features to prevent leakage or accidental release of the carbon dioxide gas. The gas storage unit can be configured with the system, such that treated gas has the option of being exhausted, of entering the greenhouse or of being stored for later use.

Although the present invention has been described in detail with reference to certain preferred configurations thereof, other versions are possible. Embodiments of the present invention can comprise any combination of compatible features shown in the various figures, and these embodiments should not be limited to those expressly illustrated and discussed. Therefore, the spirit and scope of the invention should not be limited to the versions described above.

The foregoing is intended to cover all modifications and alternative constructions falling within the spirit and scope of the invention as expressed in the appended claims, wherein no portion of the disclosure is intended, expressly or implicitly, to be dedicated to the public domain if not set forth in the claims.

We claim:

1. A waste energy recycling system, comprising:
a power plant;
one or more condensers, said one or more condensers configured to receive exhaust gas from said power plant and condense said exhaust gas, removing vapor and contaminants from said exhaust gas; and
a greenhouse configured to receive said condensed exhaust gas.

2. The waste energy recycling system of claim 1, wherein said one or more condensers is further configured to transfer heat from said exhaust gas to liquid within said one or more condensers.

3. The waste energy recycling system of claim 2, further comprising one or more liquid-to-air heat exchangers, said one or more liquid-to-air heat exchangers configured to receive said heated liquid from said one or more condensers and transfer heat from said heated liquid to air within said greenhouse.

4. The waste energy recycling system of claim 3, wherein said one or more condensers is further configured to receive cooled return liquid from said liquid-to-air heat exchangers.

5. The waste energy recycling system of claim 4, wherein said one or more condensers is further configured to transfer heat from said exhaust gas to said return liquid.

6. The waste energy recycling system of claim 5, wherein said one or more liquid-to-air heat exchangers is configured to receive said heated return liquid from said one or more condensers and transfer heat from said heated return liquid to air within said greenhouse.

7. The waste energy recycling system of claim 3, further comprising a liquid storage tank configured to receive said heated liquid from said one or more condensers and transfer heat from said heated liquid to air within said greenhouse to store for later use.

8. The waste energy recycling system of claim 7, wherein said one or more liquid-to-air heat exchangers is configured to receive heated liquid from said liquid storage tank.

9. The waste energy recycling system of claim 1, wherein said condensed exhaust gas has a higher concentration of carbon dioxide than said exhaust gas exhausted from said power plant.

10. The waste energy recycling system of claim 1, further comprising an exhaust mechanism configured to exhaust unwanted gas from the system.

11. A waste energy recycling system for use with a greenhouse, comprising:
a power plant;
one or more condensers, said one or more condensers configured to receive exhaust gas from said power plant and transfer heat from said exhaust gas to liquid within said one or more condensers; and
one or more liquid-to-air heat exchangers, said one or more liquid-to-air heat exchangers configured to receive said heated liquid from said one or more condensers and transfer heat from said heated liquid to air within said greenhouse.

12. The waste energy recycling system of claim 11, wherein said one or more condensers is further configured to receive cooled return liquid from said liquid-to-air heat exchangers.

13. The waste energy recycling system of claim 12, wherein said one or more condensers is further configured to transfer heat from said exhaust gas to said return liquid.

14. The waste energy recycling system of claim 13, wherein said one or more liquid-to-air heat exchangers is configured to receive said heated return liquid from said one or more condensers and transfer heat from said heated return liquid to air within said greenhouse.

15. The waste energy recycling system of claim 11, further comprising a liquid storage tank configured to receive said heated liquid from said one or more condensers and transfer heat from said heated liquid to air within said greenhouse to store for later use.

16. The waste energy recycling system of claim 15, wherein said one or more liquid-to-air heat exchangers is configured to receive heated liquid from said liquid storage tank.

17. A waste energy recycling system for use with a greenhouse, comprising:
a power plant configured to produce exhaust gas comprising carbon dioxide;
one or more condensers, said one or more condensers configured to receive said exhaust gas from said power plant and transfer heat from said exhaust gas to liquid within said one or more condensers, removing at least some vapor and contaminants from said exhaust gas and producing treated exhaust gas with a higher concentration of carbon dioxide;
one or more conduits configured to transport said treated exhaust gas to said greenhouse;
one or more liquid-to-air heat exchangers in said greenhouse, said one or more liquid-to-air heat exchangers configured to receive said heated liquid from said one or more condensers and transfer heat from said heated liquid to air within said greenhouse.

18. The waste energy recycling system of claim 17, wherein said one or more condensers is further configured to receive cooled return liquid from said liquid-to-air heat exchangers.

19. The waste energy recycling system of claim 18, wherein said one or more condensers is further configured to transfer heat from said exhaust gas to said return liquid.

20. The waste energy recycling system of claim 17, further comprising a liquid storage tank configured to receive said heated liquid from said one or more condensers and transfer heat from said heated liquid to air within said greenhouse to store for later use.
